(19) United States
(12) Patent Application Publication
(10) Pub. No.: US 2024/0211205 A1
(43) Pub. Date: Jun. 27, 2024

(54) CONVERSATIONAL DIGITAL TWIN METHOD USING GEOGRAPHIC INFORMATION AND APPARATUS THEREOF

(71) Applicant: Korea Advanced Institute of Science and Technology, Daejeon (KR)

(72) Inventors: Woontack WOO, Daejeon (KR); Seung Youb SSIN, Daejeon (KR)

(21) Appl. No.: 18/086,187

(22) Filed: Dec. 21, 2022

(51) Int. Cl. G06F 3/16

(52) U.S. Cl. CPC G06F 3/167

(57) ABSTRACT

Disclosed are a conversational digital twin method and apparatus using geographic information. A conversational digital twin method using geographic information, which is performed by a computer device, includes obtaining geographic information data converted into 2D or 3D; visualizing the geographic information data in a terminal and providing visualized information to a user; and interacting with the terminal of the user through an artificial intelligence or a voice recognition-based chatbot using a conversational interface to manipulate the visualized information or control an external system.

The present invention was supported by the National Research Council of Science & Technology (NST) grant by the Korea government (MSIT) (No. CRC21011). Embodiments of the present disclosure described herein relate to a conversational digital twin (CDT) framework, and more particularly, relate to a conversational digital twin method and apparatus using geographic information.

### CROSS-REFERENCE TO RELATED APPLICATIONS

A claim for priority under 35 U.S.C. § 119 is made to Korean Patent Application No. 10-2021-0118569 filed on Sep. 6, 2021, in the Korean Intellectual Property Office, the entire contents of which are hereby incorporated by reference.

### BACKGROUND

During a crisis, a large amount of data is accumulated from human experience, and such accumulated data may be used to make valuable predictions in order to prevent similar crises and avoid repeating previous mistakes in the future. Such crises may be individual (e.g., diagnosis of a life-threatening illness), organizational (e.g., a company facing bankruptcy), social or global (e.g., COVID-19 pandemic). Beghetto said that crises may cause serious problems and cause anxiety among the people, but may serve as an essential catalyst for creative action and bring innovative results (Non-Patent Document 1). This is because typical reasoning and behavior may not be very helpful in a crisis situation.

Monitoring crises such as fires, terrorism, floods, gas leaks, earthquakes, heavy snowfall, and collapses using a traditional scheme such as CCTV or SNS is not ideal unless the entire problem area is monitored. Given that the spread of critical diseases such as COVID 19 has caused huge economic losses, it is now necessary to identify the causes of the crisis and act quickly to overcome the situation with minimal damage.

Previously, administrators and leaders have introduced emergency solutions to help manage urban disasters and safety within cities by using a geographic information system (GIS)-based system. In smart cities, managers conducted research to develop a disaster city digital twin with technology of monitoring remote spaces and predicting future disaster situations. The research results mentioned above have proven that the combination of disaster management technology, which can reduce damage only with real-time information, and digital twin technology, which can visually support real-time information, can effectively minimize damage caused by a crisis.

### DOCUMENT OF RELATED ART

### Non-Patent Document

(Non-patent document 1) R. A. Beghetto, “How Times of Crisis Serve as a Catalyst for Creative Action: An Agentic Perspective,” (in eng), Frontiers in Psychology, vol. 11, pp. 600685-600685, 2020, doi: 10.3389/fpsyg.2020.600685.

### SUMMARY

Embodiments of the present disclosure describe a conversational digital twin method and apparatus using geographic information. Specifically, embodiments of the present disclosure provide a digital twin framework technology that uses 2D/3D geographic information to visualize data on a smart terminal display and has a conversational interface capable of interacting with each other through natural language understanding/voice recognition-based chatbot technology.

Embodiments of the present disclosure provide an interactive digital twin method and apparatus using geographic information that manages a crisis in various aspects by connecting 3D augmented reality technology and a chatbot function through an edge computing unit.

According to an embodiment, a conversational digital twin method using geographic information performed by a computer device includes: obtaining geographic information data converted into 2D or 3D; visualizing the geographic information data in a terminal and providing visualized information to a user; and interacting with the terminal of the user through an artificial intelligence or a voice recognition-based chatbot using a conversational interface to manipulate the visualized information or control an external system.

The the obtaining of the geographic information data may include obtaining data related to at least one of geographic information, environmental information, and movement information, data collected from at least one of virtual IoT and real IoT, and the geographic information data converted into 2D or 3D to be visualized and expressed on a display of the terminal.

The obtaining of the geographic information data may include obtaining a location of at least one of IoT, AIoT and a smart device registered in a geographic information system (GIS), which is geographical emergency management (GEM) in a digital twin space, and enabling data analysis through ground real world object simulation and control.

The providing of the visualized information may include visualizing and expressing the visualized information on a display of at least one of an AR terminal, an MR terminal, a VR terminal, and a smart terminal.

The providing of the visualized information may include visualizing the visualized information collected on a map including a structure, and expressing the visualized information through data visualization or augmented-virtual reality visualization technology.

The chatbot may include a conversational AI chatbot integrating voice recognition and natural language understanding technology.

The conversational digital twin method may further include supporting a decision-making of the user in a digital twin space by connecting a 3D augmented reality technology for visualizing the geographic information data and a conversational chatbot through an edge computing unit, and managing and responding to a specific situation.

According to another embodiment, a conversational digital twin apparatus using geographic information includes a geographic information collection unit configured to obtain geographic information data converted into 2D or 3D; an information visualization unit configured to visualize the geographic information data in a terminal and provide visualized information to a user; and an interaction unit configured to interact with the terminal of the user through an artificial intelligence or a voice recognition-based chatbot by using a conversational interface to manipulate the visualized information or control an external system.

The geographic information collection unit may obtain data related to at least one of geographic information, environmental information, and movement information, data collected from at least one of virtual IoT and real IoT, and the geographic information data converted into 2D or 3D to be visualized and expressed on a display of the terminal.

The geographic information collection unit may obtain a location of at least one of IoT, AIoT and a smart device registered in a geographic information system (GIS), which is geographical emergency management (GEM) in a digital twin space, and enable data analysis through ground real world object simulation and control.

The information visualization unit may visualize and express the visualized information on a display of at least one of an AR terminal, an MR terminal, a VR terminal, and a smart terminal.

The information visualization unit may visualize the visualized information collected on a map including a structure, and express the visualized information through data visualization or augmented-virtual reality visualization technology.

The chatbot may include a conversational AI chatbot integrating voice recognition and natural language understanding technology.

A decision-making of the user in a digital twin space may be supported by connecting a 3D augmented reality technology for visualizing the geographic information data and a conversational chatbot through an edge computing unit, and a specific situation is managed and responded to.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a diagram schematically illustrating a conversational digital twin for geographic emergency management (CDT-GEM) according to an embodiment:

FIG. 2 is a flowchart illustrating a conversational digital twin method using geographic information according to an embodiment:

FIG. 3 is a block diagram illustrating a conversational digital twin apparatus using geographic information according to an embodiment; and

FIG. 4 is a diagram illustrating the structure of a conversational digital twin for geographic emergency management (CDT-GEM) according to an embodiment.

### DETAILED DESCRIPTION

Hereinafter, preferable embodiments of the present disclosure will be described in detail with reference to accompanying drawings. However, the spirit and technical scope of the present disclosure is not limited to the embodiments and may be modified variously in many different forms. In addition, the embodiments are given to provide complete disclosure of the present disclosure and to provide thorough understanding of the present disclosure to those skilled in the art. In addition, the shapes and the sizes of the components shown in the drawings may be exaggerated for clarity of explanation.

The continuous development of cities toward smartization is mainly driven by modern information & communication technology (ICT) techniques that may be used to extract and analyze meaningful data from the entire city and realize advanced visualization. However, despite smartization efforts, there is a lack of tools that can support intelligent responses to sustain emergencies or sudden disasters. Currently, numerous city researchers focus on designing city management tools that can be linked with various Internet of Things (IoT) tools in order to combine digital twin technology with extended reality (XR) and voice recognition AI, and integrate and manage extracted sensing data.

Embodiments propose conversational digital twin for geographic emergency management (CDT-GEM) which is a digital twin system that informs managers of situations that have occurred in a crisis situation and supports citizens to communicate with the emergency management system in real time. In more detail, embodiments provide a digital twin framework technology that utilizes 2D/3D geographic information to visualize data on a smart terminal display (e.g., a smart pad, AR/MR HMD, and the like) and interact through natural language understanding/voice recognition-based chatbot technology.

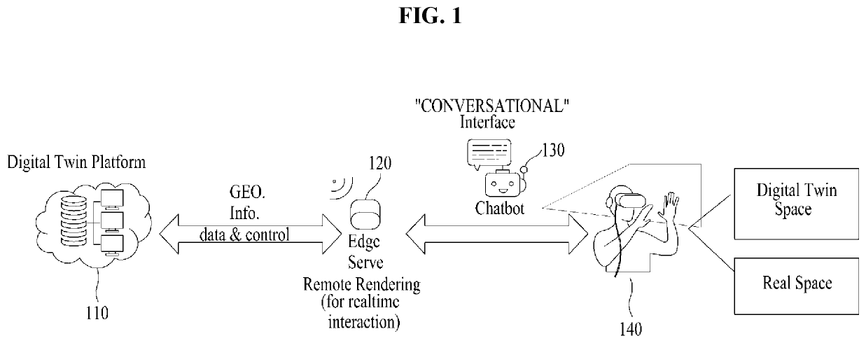

FIG. 1 is a diagram schematically illustrating a conversational digital twin for geographic emergency management (CDT-GEM) according to an embodiment.

As shown in FIG. 1, a demonstration system, which is called a conversational digital twin for geographic emergency management (CDT-GEM), may be introduced as a tool that both managers and citizens can utilize in a crisis situation. Unlike traditional digital twins, the CDT-GEM has an AI system built into the chat that allows users to make appropriate decisions in real time.

The digital twin technology is a technique that implements objects and spaces of the physical world in a digital twin space with a model, derives optimal results through simulation and interaction in various environments or conditions in the digital twin space, and then applies and synchronizes them to the physical world. In summary, the digital twin is a real virtual world synchronization technology based on simulation and interaction. Modeling of a target (object, system or infrastructure) in the physical world is an essential element of digital twin technology. In particular, when the modeled object can interact in a digital twin space connected to a geographic information system (GIS), the effect of the digital twin may be enhanced. Internet of Things (IoT) and artificial intelligence of things (AIoT) devices such as intelligent CCTVs, and smart streetlights directly affect people's lives. Such devices transmit measured or sensed data to a data system through the Internet. When the locations of the devices registered in GIS in a digital twin space are known, data analysis through real-world object simulation and control may be easy.

Through a conversational chatbot interface, an AR/VR/MR/XR interface, and the like, a user may access the digital twin system to check and interact with visualized/digitized data. A conversation interface of a chatbot is a kind of user interface that mimics a chat or voice conversation with a real person. A conversational AI chatbot (integrated with speech recognition and conversation understanding technologies) may enable efficient and convenient monitoring and control of tools in the digital twin space. Users may easily transfer their intentions to the AI system of the digital twin through voice, and may understand a significant amount of information using conversational computer graphics and visualization techniques such as AR/VR/MR. A chatbot such as an interactive AI assistant provides meaningful data to a human user by comprehensively analyzing large amounts of data generated by IoT and AIoT devices. In addition, it helps users to retrieve and transmit information that is not received through an external network. The platform proposed in the embodiment supports human decision-making in the digital twin space by combining with a conversational AI chatbot, which is called a conversational digital twin (CDT).

The digital twin is widely used for an emergency management and response system to ensure security and disaster safety. The system is linked to GIS, which is geographical emergency management (GEM), to monitor living spaces where human users and artificial intelligence collaborate. A conversational AI chatbot informs a human user of a dangerous situation and rescue situation that may be missed and provides an appropriate countermeasure as a countermeasure. Human users may use the system to easily and intuitively control an emergency situation through voice or other natural user interface (NUI) devices. A user may utilize an HMD, wearable device and tablet that can be synchronized with the digital twin space through a NUI device. In addition, such a device enables interaction with the digital twin space modeled in 3D.

Currently, Korea Advanced Institute of Science and Technology (KAIST) has developed a system that can monitor the energy consumption of each building by modeling buildings in the campus and interacting with a hololens through a tabletop. In addition, the ETRI created a conversational AI chatbot that can respond to civil complaints by using a chatbot capable of voice recognition and conversation at the National Police Agency's call center. The conversational AI chatbot of the ETRI may also be used to develop a digital twin-based smart public order platform, such as assault or arson detection and suspect escape route tracking. In the conversational digital twin (CDT), a platform or system is connected to the cloud through an edge computing server or mobile edge to perform high-speed 3D rendering and information integration analysis. The performance of a digital twin visualization interface (e.g., AR/XR HMD) may be improved in real time by utilizing the remote rendering technology of an edge computing device.

Large-scale big data is generated due to strong connectivity with IoT and AIot devices as well as an external network platform (through the cloud). In this regard, a conversational AI chatbot should be able to analyze big data according to the characteristics. Through the use of a conversational AI chatbot, the information analysis cost may be reduced and valuable information may be created.

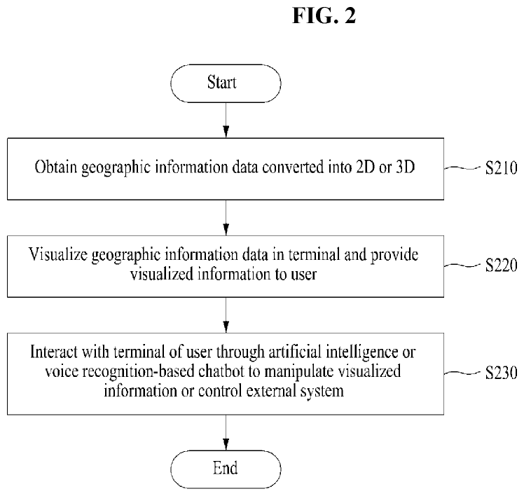

FIG. 2 is a flowchart illustrating a conversational digital twin method using geographic information according to an embodiment.

Referring to FIG. 2, a conversational digital twin method using geographic information performed by a computer device according to an embodiment may include operation S210 of obtaining geographic information data converted into 2D or 3D, operation S220 of visualizing the geographic information data in a terminal and providing visualized information to a user, and operation S230 of interacting with the terminal of the user through an artificial intelligence or a voice recognition-based chatbot using a conversational interface to manipulate the visualized information or control an external system.

Embodiments may provide a new concept digital twin technology that can manage a wide range of areas by linking a conversational AI chatbot with a digital twin through natural language processing. Embodiments can achieve a great leap in the combination of natural language processing and digital twin compared to an existing text chatbot system. In addition, as a digital twin technology using a natural language processing AI, it is possible to provide an advanced system compared to smart city services focused only on existing visualization.

A conversational digital twin method using geographic information performed by a computer device according to an embodiment may be described with a conversational digital twin apparatus using geographic information according to an embodiment as an example.

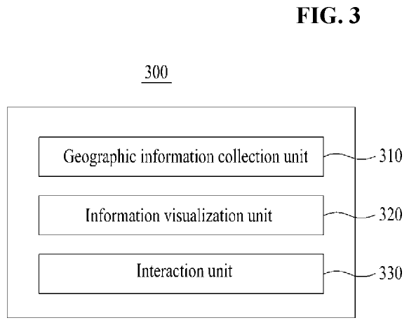

FIG. 3 is a block diagram illustrating a conversational digital twin apparatus using geographic information according to an embodiment.

Referring to FIG. 3, a conversational digital twin device 300 using geographic information according to an embodiment may include a geographic information collection unit 310, an information visualization unit 320, and an interaction unit 330.

In operation S210, the geographic information collection unit 310 may obtain geographic information data converted into 2D or 3D.

The geographic information collection unit 310 may obtain data related to at least one of geographic information, environmental information, and movement information, data collected from at least one of virtual IoT and real IoT, and the geographic information data converted into 2D or 3D to be visualized and expressed on a display of the terminal. In detail, the geographic information collection unit 310 may use, as an input, data on geographic information, environmental information, movement information (movement of a vehicle, and the like), data collected/analyzed from virtual/real IoT, and 2D or 3D-to-2D converted geospatial information data to be visualized and expressed on a display of a smart terminal (smart pad, a table top, and the like).

The geographic information collection unit 310 may obtain a location of at least one of IoT, AIoT and a smart device registered in a geographic information system (GIS), which is geographical emergency management (GEM) in a digital twin space, and enable data analysis through ground real world object simulation and control.

In step S220, the information visualization unit 320 may visualize the geographic information data in a terminal and provide visualized information to a user.

In detail, the information visualization unit 320 may visualize and express the visualized information on a display of at least one of an AR terminal, an MR terminal, a VR terminal, and a smart terminal. In more detail, the information visualization unit 320 may express the collected 2D/3D geospatial data in a smart terminal (a smart pad, a tabletop, or the like) as well as an AR/MR terminal such as a hololens or a VR terminal with data visualization or augmented-virtual reality visualization technology (e.g., visualization of collected information of virtual/real IoT on a city map including 3D structures).

Specifically, the information visualization unit 320 may visualize the visualized information collected on a map including a structure, and express the visualized information through data visualization or augmented-virtual reality visualization technology.

In step S230, the interaction unit 330 may interact with the terminal of the user through an artificial intelligence or a voice recognition-based chatbot by using a conversational interface to manipulate the visualized information or control an external system. In this case, the chatbot may be a conversational AI chatbot in which voice recognition and natural language understanding technologies are integrated.

Embodiments are a digital twin framework technology that operates through linkage with individual systems, such as IoT systems, cloud systems, edge computing, AI chatbot systems, and the like, in this structure and linkage with components of each system layer. Specifically, embodiments may support user decision-making in the digital twin space by connecting 3D augmented reality technology that visualizes geospatial data through an edge computing unit and a conversational chatbot, and manage and respond to a specific situation.

The digital twin is a technology that all cities aiming for a smart city are trying to introduce, and a conversational AI system for natural language processing is a technology that is essential for public institutions that need to support services with a small number of people. When these two systems, that is, the digital twin and the conversational AI system, are combined, a variety of public services may be applied to a smart city.

Accordingly, it is possible to support a system for insufficient emergency management personnel. It is possible to reduce the workload of a small number of administrators by handling a large part of the social overload of handling numerous emergency reports in the initial response through a digital twin and a conversational AI.

Embodiments may be utilized in fields such as urban disaster safety, public order, transportation, and the like using geographic information data, and may be scalable in combination with smart city technology. By using augmented reality tools, 2D/3D geographic information may be visualized on a 3D city space, and may be utilized to allow system operators, urban designers, managers, and citizens to interact with each other through a conversational interface, thereby optimizing urban design and urban system operation.

For example, according to the embodiments, through the production by geographical visualization techniques, a system may manage/verify the location, time, and situation of an emergency situation to help a critical emergency in which golden time is important, and areas and situations with high management importance may be predicted by using accumulated information.

In addition, the embodiments may provide an interface through which citizens and administrators can easily communicate. According to the embodiments, it is possible to induce smooth conversation between citizens and administrators by providing an easy conversational interface for communicating with administrators when an emergency situation occurs.

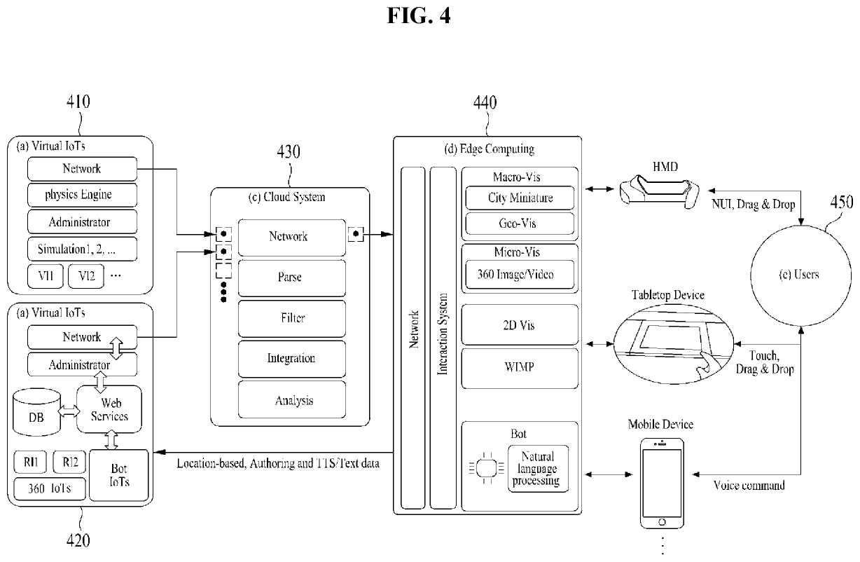

FIG. 4 is a diagram illustrating the structure of a conversational digital twin for geographic emergency management (CDT-GEM) according to an embodiment.

A structure of a conversational digital twin for geographic emergency management (CDT-GEM) may be designed such that an administrator can monitor an emergency situation occurring in urban space and transmit information between multiple citizens and the administrator in real time at a remote location. Referring to FIG. 4, a CDT-GEM may include a virtual IoT 410, a real IoT 420, a cloud system 430, an edge computing unit 440, and a user 450. As shown, each component may be connected to various devices. In this case, the user 450 may access the edge computing unit 440 through a terminal.

The virtual IoT 410 is a server system unit that virtually generates data. The virtual IoT 410 may be used when a city manager (user 450) desires to perform a test by combining natural phenomena and virtual simulations in the city center. When the real IoT 420 cannot be expressed or rich information cannot be provided, the virtual IoT 410 may design an innovation city service by creating useful data that supplements the data of the real IoT 420.

The real IoT 420 is a system capable of managing already existing IoT systems at a specific point in time by combining existing IoT systems. In this case, reference numerals RI1 and RI2 represent connected existing real IoT. The IoT 360 is a technology that expresses the location of an object by using an image. The BoT IoT may use the information received from a voice recognition system of a mobile device as sensing data by representing the information as data.

The cloud system 430 provides a cloud service by utilizing large-capacity server systems such as Microsoft Azure, AWS, Google Cloud, and the like, and receives data generated by the virtual IoT 410 and the real IoT 420 systems as an input. The cloud system 430 parses, combines, and analyzes the extracted input data.

The edge computing unit 440 outputs the information finally received from the cloud system 430 and converts it into a form that the user 450 can easily understand and use.

Meanwhile, the HMD is a part in which a city manager and citizens (user 450) use an extended reality (XR) HMD such as a Microsoft hololens.

Space-time information input through the network of the edge computing unit 440 is classified for microscopic visualization using 360 technology and macroscopic visualization using a scheme of city reduction. A city miniature is used to visualize geographic information using a city map (Geo-Vis). In 360 technology (360 Image/Video), monitoring technology such as CCTV and remote visits inside buildings such as non-face-to-face performances are provided.

A tabletop device is an interaction system that provides a touch function of easily controlling information outside of a viewport, and it is inconvenient to process the information together with NUI of HMD on a 2D plane. The tabletop device provides various selection menus, information presentation such as moving of 2D object movement and zooming in/out of a geographic map, and an interactive function such as drag and drop.

The bot system operating through a mobile device processes a natural language input of the user 450, converts the natural language input into event-type text, provides guidance to those who need it, and helps a manager perform a required function. The location and status information generated by a mobile device may be converted into IoT information and stored in a system.

The user 450 who is a city manager or citizen refers to a group responsible for identifying and handling problems by accessing the edge computing unit 440 by using various terminals (e.g., an HMD, a tabletop device, or a mobile device described above) to transmit information and provide necessary data to an external manager.

The digital twin technology may extract spatiotemporal information by analyzing the situation at a crisis/disaster site. However, it is necessary to improve the interface that can flexibly connect a city manager and citizens in cyberspace composed of digital twins. An AI-based chatbot system may be used as an interactive interface where the digital twin can quickly and conveniently deliver highly valuable information to the user 450 by analyzing input data. In addition, it is possible to design an emergency management platform based on geographic information by using augmented reality technology.

In the proposed CDT-GEM, the crisis is managed in various aspects by connecting 3D augmented reality technology and chatbot functions through the edge computing unit 440. A user-friendly integrated approach may be easily configured with the help of 5G edge technology, cloud technology, XR HMD, and an AI chatbot system. Thus, an integrated system may be used for smart crisis management. As described above, the embodiments may present technologies essential to risk management and provide a system capable of designing smart services by using specific technologies.

The foregoing devices may be realized by hardware elements, software elements and/or combinations thereof. For example, the devices and components illustrated in the exemplary embodiments of the present disclosure may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A processing unit may implement an operating system (OS) or one or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively control the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner. Software and data may be recorded in one or more computer-readable storage media.

The methods according to the above-described exemplary embodiments of the present disclosure may be implemented with program instructions which may be executed through various computer means and may be recorded in computer-readable media. The media may also include, alone or in combination with the program instructions, data files, data structures, and the like. The program instructions recorded in the media may be designed and configured specially for the exemplary embodiments of the present disclosure or be known and available to those skilled in computer software. Computer-readable media include magnetic media such as hard disks, floppy disks, and magnetic tape: optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter.

According to the embodiments, it is possible to provide a conversational digital twin method and apparatus using geographic information that use 2D/3D geographic information to visualize data on a smart terminal display and have a conversational interface capable of interacting with each other through natural language understanding/voice recognition-based chatbot technology.

In addition, according to the embodiments, it is possible to provide an interactive digital twin method and apparatus using geographic information that manages a crisis in various aspects by connecting 3D augmented reality technology and a chatbot function through an edge computing unit.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Thus, it is intended that the present disclosure covers other realizations and other embodiments of the present disclosure provided they come within the scope of the appended claims and their equivalents.

1. A conversational digital twin method using geographic information performed by a computer device, the conversational digital twin method comprising:
obtaining geographic information converted into 2D or 3D of structures and devices in an urban area during a situation;
visualizing the geographic information in a terminal and providing a visualized digital twin of the urban area including the structures and devices to a first user;
receiving, at the terminal and during the situation, a natural language input related to the situation from the first user;
converting the natural language input to text indicating an event type by a chatbot;
communicating the text indicating the event type to a second user, wherein the second user is a manager of the situation and the second user is remote from first user.

2. The conversational digital twin method of claim 1, wherein the obtaining of the geographic information data includes:
obtaining data related to at least one of geographic information, environmental information, and movement information, data collected from at least one of virtual IoT and real IoT, and the geographic information data converted into 2D or 3D to be visualized and expressed on a display of the terminal.

3. The conversational digital twin method of claim 1, wherein the obtaining of the geographic information data includes:
obtaining a location of at least one of IoT, AIoT and a smart device registered in a geographic information system (GIS), which is geographical emergency management (GEM) in a digital twin space, and enabling data analysis through ground real world object simulation and control.

4. The conversational digital twin method of claim 1, wherein the providing of the visualized information includes:
visualizing and expressing the visualized information on a display of at least one of an AR terminal, an MR terminal, a VR terminal, and a smart terminal.

5. The conversational digital twin method of claim 1, wherein the providing of the visualized information includes:
visualizing the visualized information collected on a map including a structure, and expressing the visualized information through data visualization or augmented-virtual reality visualization technology.

6. The conversational digital twin method of claim 1, wherein the chatbot includes a conversational AI chatbot integrating voice recognition and natural language understanding technology.

7. The conversational digital twin method of claim 1, further comprising:
supporting a decision-making of the user in a digital twin space by connecting a 3D augmented reality technology for visualizing the geographic information data and a conversational chatbot through an edge computing unit, and managing and responding to a specific situation.

8. A conversational digital twin apparatus using geographic information, the conversational digital twin apparatus comprising:
a geographic information collection unit configured to obtain geographic information converted into 2D or 3D of structures and devices in an urban area during a situation;
an information visualization unit configured to visualize the geographic information in a terminal and provide a visualized digital twin of the urban area including the structures and devices to a first user; and
an interaction unit configured to:
receive, at the terminal and during the situation, a natural language input related to the situation from the first user;
convert the natural language input to text indicating an event type by a chatbot;
communicate the text indicating the event type to a second user, wherein the second user is a manager of the situation and the second user is remote from first user.

9. The conversational digital twin apparatus of claim 8, wherein the geographic information collection unit is configured to:
obtain data related to at least one of geographic information, environmental information, and movement information, data collected from at least one of virtual IoT and real IoT, and the geographic information data converted into 2D or 3D to be visualized and expressed on a display of the terminal.

10. The conversational digital twin apparatus of claim 8, wherein the geographic information collection unit is configured to:
obtain a location of at least one of IoT, AIoT and a smart device registered in a geographic information system (GIS), which is geographical emergency management (GEM) in a digital twin space, and enable data analysis through ground real world object simulation and control.

11. The conversational digital twin apparatus of claim 8, wherein the information visualization unit is configured to:
visualize and express the visualized information on a display of at least one of an AR terminal, an MR terminal, a VR terminal, and a smart terminal.

12. The conversational digital twin apparatus of claim 8, wherein the information visualization unit is configured to:
visualize the visualized information collected on a map including a structure, and express the visualized information through data visualization or augmented-virtual reality visualization technology.

13. The conversational digital twin apparatus of claim 8, wherein the chatbot includes a conversational AI chatbot integrating voice recognition and natural language understanding technology.

14. The conversational digital twin apparatus of claim 8, wherein a decision-making of the user in a digital twin space is supported by connecting a 3D augmented reality technology for visualizing the geographic information data and a conversational chatbot through an edge computing unit, and a specific situation is managed and responded to.

15. The method of claim 1, further comprising:
obtaining second geographic information, the second geographic information based on a response of the second user to the text indicating the event type; and
visualizing the second geographic information in the terminal.
